(19) United States
(12) Patent Application Publication
(10) Pub. No.: US 2023/0063236 A1
(43) Pub. Date: Mar. 2, 2023

(54) Extension Assembly: Methods of Use and Methods of Making

(71) Applicant: FarmX Inc., Mountain View, CA (US)

(72) Inventor: John Milford Smithers, Mountain View, CA (US)

(21) Appl. No.: 17/877,448

(22) Filed: Jul. 29, 2022

Related U.S. Application Data
(60) Provisional application No. 63/236,446, filed on Aug. 24, 2021.

(51) Int. Cl. H01Q 1/12

(52) U.S. Cl. CPC H01Q 1/1228; H01Q 1/1235

(57) ABSTRACT

Exemplary methods for making an extension assembly include marking on a ¾″ conduit a line 2 feet from one end, inserting the marked end of the ¾″ conduit into a 1″ conduit until about 9″ of the ¾″ conduit is exposed, and without putting on a nut, assembling one 1⅜″ ID U-bolt onto the ¾″ conduit at a point the ¾″ conduit enters the 1″ conduit.

### CROSS-REFERENCE TO RELATED APPLICATIONS

This Non-Provisional Patent Application claims the priority benefit of U.S. Provisional Patent Application Ser. No. 63/236,446 filed on Aug. 24, 2021 titled “Extension Assembly: Methods of Use and Methods of Making,” which is hereby incorporated herein in its entirety.

### SUMMARY

Exemplary methods for making an extension assembly include marking on a ¾″ conduit a line 2 feet from one end, inserting the marked end of the ¾″ conduit into a 1″ conduit until about 9″ of the ¾″ conduit is exposed, and without putting on a nut, assembling one 1⅜″ ID U-bolt onto the ¾″ conduit at a point the ¾″ conduit enters the 1″ conduit.

Loosely attaching two mounting plates one to each end of the one 1⅜″ ID U-bolt with nuts, according to exemplary embodiments, and leaving other ends of the two mounting plates unattached may also be provided. Exemplary methods include assembling another 1⅜″ ID U-bolt onto the 1″ conduit and loosely attaching it to the unattached ends of the two mounting plates. Lightly tightening with a nut a U-bolt on the ¾″ conduit, and sliding the ¾″ conduit out just enough to make certain it is not grabbing the 1″ conduit and tightening it until snug may also be part of the process. Additionally, sliding the ¾″ conduit back into the 1″ conduit until the U-bolt comes to a stop and tightening the U-bolt on the 1″ conduit, marking the 1″ conduit 4 feet from the end and opposite of the U-bolts, attaching an antenna array to a top of the ¾″ conduit, and inserting the ¾″ conduit/antenna array assembly into a fence post may take the process closer to completion, including assembling 2″ ID U-bolts onto the fence post, and attaching a radio base station or similar equipment to the extension assembly.

An exemplary extension assembly may include a ¾″ conduit having a line marked 2 feet from one end with the marked end of the ¾″ conduit inserted into a 1″ conduit until about 9″ of the ¾″ conduit is exposed, and one 1⅜″ ID U-bolt assembled onto the ¾″ conduit at a point the ¾″ conduit enters the 1″ conduit. Two mounting plates loosely attached with nuts one to each end of the one 1⅜″ ID U-bolt, leaving other ends of the two mounting plates unattached may also be included. Another 1⅜″ ID U-bolt may be assembled onto the 1″ conduit and loosely attached to the unattached ends of the two mounting plates. A U-bolt may be lightly tightened with a nut on the ¾″ conduit. The ¾″ conduit may be moved out just enough to make certain it is not grabbing the 1″ conduit and tightened until snug. The ¾″ conduit may be moved back into the 1″ conduit until the U-bolt has stopped and tightened to the U-bolt on the 1″ conduit. The 1″ conduit may be 4 feet from the end and opposite of the U-bolts and an antenna array may be attached to a top of the ¾″ conduit.

Further exemplary methods include a method of using an extension assembly, including decoupling the extension (height) from the rotation (azimuth) by adjusting the height, and independently positioning the azimuth without a conduit suddenly falling down in a reverse telescopic way.

### BRIEF DESCRIPTION OF THE DRAWINGS

FIG. 1 shows exemplary components of an extension assembly.

FIG. 2 shows two views: an exemplary fence post to one inch conduit front and an exemplary fence post to one inch conduit side.

FIG. 3 shows two views: an exemplary one inch to three-quarters inch conduit front and an exemplary one inch to three-quarters inch conduit side.

FIG. 4 shows two views: an exemplary full assembly (without equipment) and an exemplary azimuth and height adjustment.

### DESCRIPTION OF EXEMPLARY EMBODIMENTS

It should be understood the disclosed embodiments are merely exemplary, which may be embodied in multiple forms. Those details disclosed herein are not to be interpreted in any form as limiting, but as the basis for the claims.

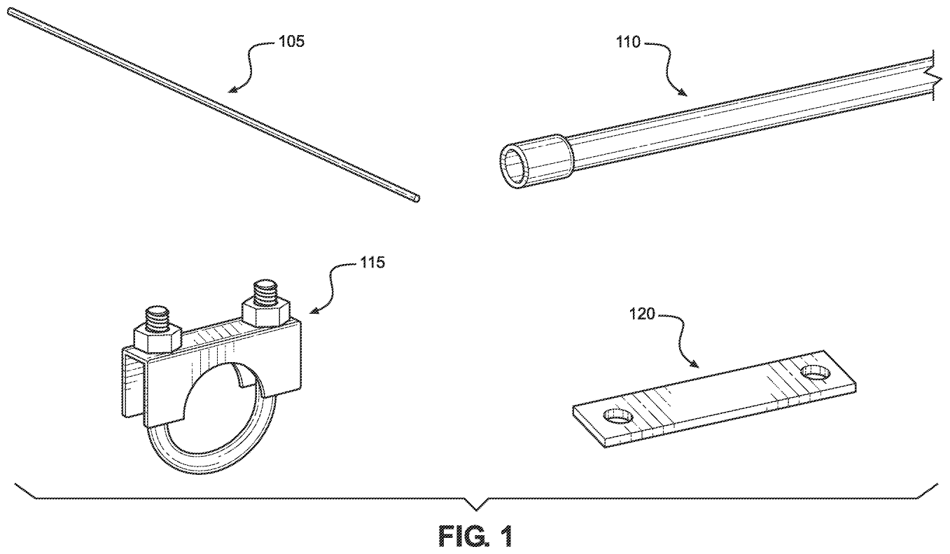

FIG. 1 shows exemplary components of an extension assembly. According to various exemplary embodiments, the extension assembly comprises:

One 1⅝″×8 ft 16-gauge galvanized steel fence post 105.

One 1″×10 ft intermediate (or rigid) metal conduit 110.

Three clamping U-bolts, steel, 5/16″-18 thread size, 1⅜″ ID 115 (one shown).

Four mounting plates for 5/16″-18 thread size, 2½″ ID galvanized steel U-bolt 120 (one shown).

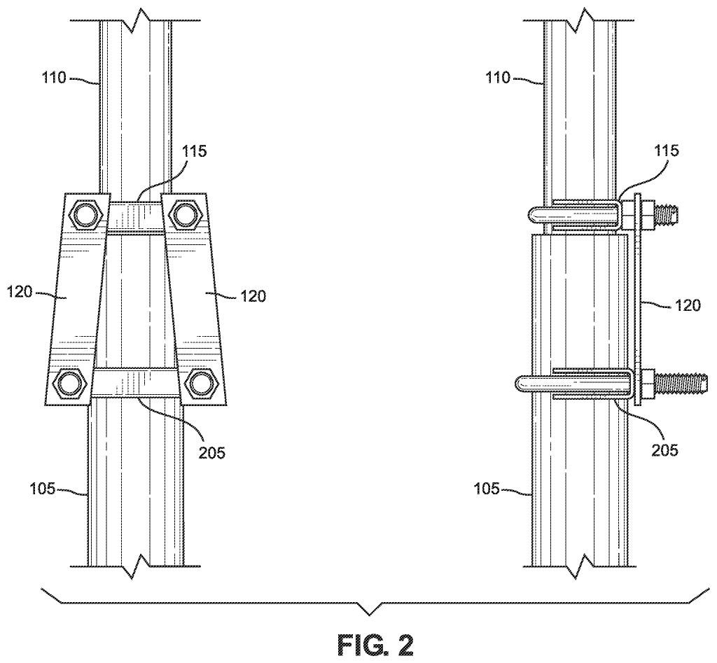

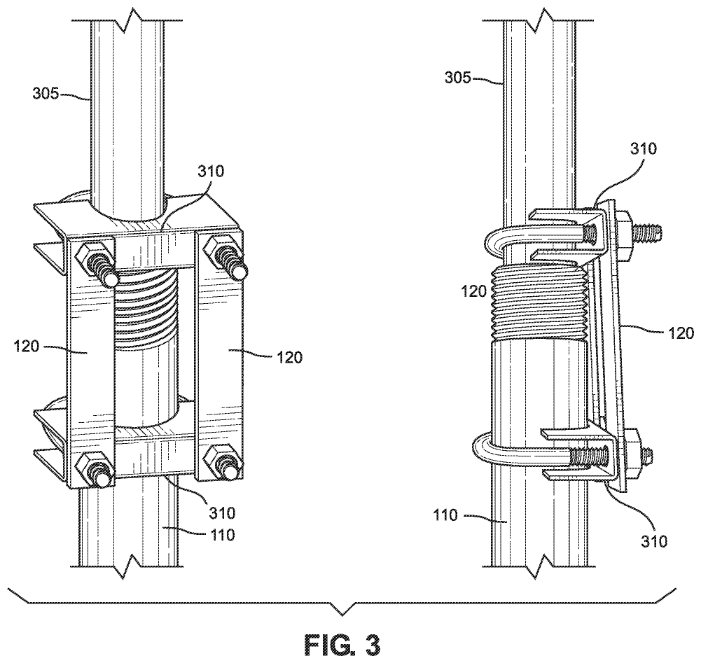

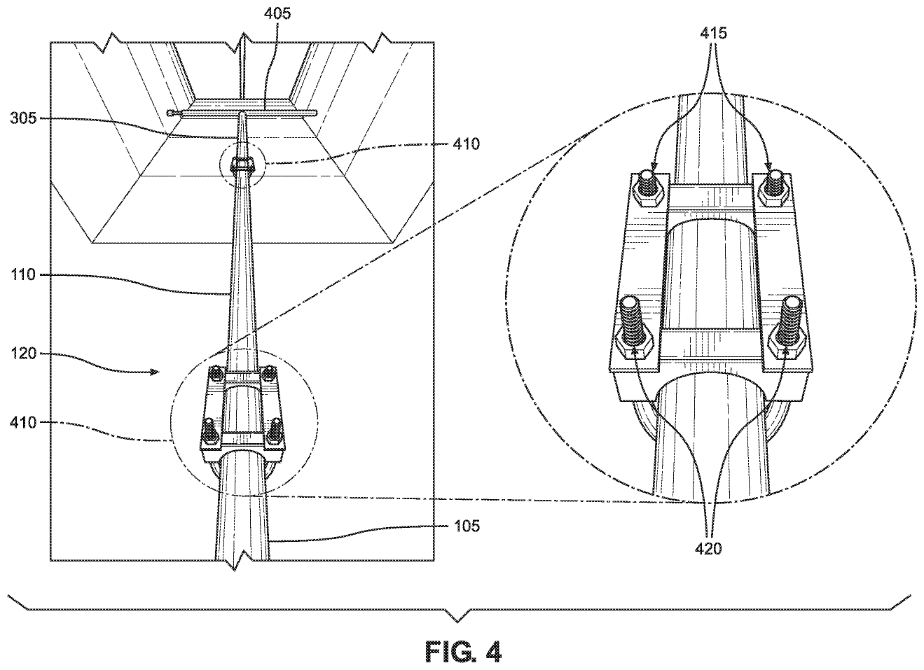

FIGS. 2-4 show an exemplary extension assembly.

According to most exemplary embodiments, the smallest diameter conduit 305 fits inside the larger diameter conduit 110. The larger diameter conduit 110 fits inside the fence post 105. The clamping U-bolts 115 are sized to properly clamp the respective fence post 105 or larger diameter conduit 110. The mounting plates 120 are long enough to bridge from fence post 105 to conduit 305 and from larger diameter conduit 110 to smaller conduit 305 while having holes sized to accommodate the threaded portions of the U-bolts 115. Install the fence post into the ground as appropriate for the site.

Exemplary methods may include removing the threaded bushings (if present) attached to the ¾″ conduit 305 and the 1″ conduit 110. Take the ¾″ conduit 305 and mark a line 2 feet from one end. Insert the marked end of the ¾″ conduit 305 into the 1″ conduit 110 and keep inserting until about 9″ is still exposed. Without putting on the nuts, assemble one of the 1⅜″ ID U-bolts 115 onto the ¾″ conduit 305 at the point it enters the 1″ conduit 110. Take two mounting plates 120 and loosely attach one to each end of the U-bolt 115 with the nuts, leaving the other end of the mounting plates 120 unattached. Assemble another one of the 1⅜″ ID U-bolts 115 onto the 1″ conduit 110 and loosely attach them to the other ends of the mounting plates 120 with the nuts that came with the U-bolts 115. Lightly tighten U-bolt 115 on the ¾″ conduit 305. Slide the ¾″ conduit 305 out just enough to make certain it is not grabbing the 1″ conduit 110 and tighten until snug. Slide the conduit 305 back into the 1″ conduit 110 until the U-bolt 115 comes to a stop. Tighten the U-bolt 115 on the 1″ conduit 110. Mark the 1″ conduit 110 4 feet from the end opposite the U-bolts 115. Attach antenna array 405 to the top of the ¾″ conduit 305 as appropriate. Insert conduit 110/antenna assembly 405 into fence post 105. A ladder may be needed from this point on. Assemble the 2″ ID U-bolts 205 onto the fence post 110 and loosely attach it to the other ends of the mounting plates 120 with the nuts that came with the U-bolt 205. Slide both U-bolts 115 down until the one on the 1″ conduit 110 rests on top of the fence post 105. Snugly tighten all nuts on both U-bolts 115.

Attach cable(s) to antenna array 405. With a firm grip on the ¾″ conduit 305 (or using a clamp) to prevent the conduit 110 from collapsing, loosen the top U-bolt 305 nuts enough to be able to raise the antenna 405. Raise (or telescope) the antenna 405 with the ¾″ conduit 305, securing the cable(s) along the way, as high as desired, but no further than the 2-foot mark drawn on the conduit 110 and snug all nuts.

If further height is needed, above the fence post 105, loosen the 1″ conduit 110 U-bolt 115 and raise the antenna 405, with a firm grip on the conduit 110 (or clamp), securing the cable(s) along the way until the desired height is met, but not further than the 4-foot mark drawn on the 1″ conduit 110. Snugly tighten the nuts on the U-bolt 115 attached to the 1″ conduit 110.

If the azimuth 420 of the antenna 405 needs to be adjusted, loosen the fence post 105 U-bolt 305 and turn the antenna 405 until the desired angle for best reception/transmission is found, then tighten the U-bolt 305.

Additional information: equipment that requires the antenna 405 may be mounted to the fence post 105 or conduit 110 as allowed by weight or other mechanical considerations. That equipment may be battery boxes, solar panels and weather stations (both of which require azimuth adjustments), etc. Additionally, other pieces of equipment may be used in addition to or in place of the antenna 405, including a radio base station or similar equipment.

Advantages include:

Exemplary embodiments are made of off-the-shelf materials/components that are less expensive and easier to acquire than proprietary ready-made posts.

Many of the components can be bought at a local hardware store, saving money in shipping, and time for a ready-made post to be delivered.

The components are commonly carried by hardware and automotive web sites, as well as Amazon and their competitors and money can be saved looking for competitive prices.

This exemplary solution controls not only the elevation of the antenna but also independently allows the installer to adjust the antenna's azimuth and tune the antenna's angle for best reception and transmission. This makes installation and setup easier and safer for the installer. Additionally, the exemplary solution revolves around the “decoupling” of the extension (height) from the rotation (azimuth). One can adjust the height which is generally the more rigorous and less safe action (especially on a ladder) without needing to worry about the azimuth at the same time. Once the height is set, then one can independently position the azimuth without worry about the tubes suddenly falling down in a reverse telescopic means. Not only is the original setup of the post easier, but if one has an item on the post that needs repositioning (e.g., solar panel), it generally needs to be positioned in azimuth only. Thus, again with decouple clamping, this can be achieved in a safer manner.

Further, this exemplary solution only requires tubes/pipes without any end features. In contrast, Telespar tubing requires holes through the tube. Other means of clamping generally require slots or other end features to be cut—increasing cost and complexity. This exemplary solution needs the tube inside another tube to be present without any end treatments.

While various embodiments have been described above, it should be understood that they have been presented by way of example only, and not limitation. The descriptions are not intended to limit the scope of the present technology to the particular forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

What is claimed:

1. A method for making an extension assembly comprising:
marking on a ¾″ conduit a line 2 feet from one end;
inserting the marked end of the ¾″ conduit into a 1″ conduit until about 9″ of the ¾″ conduit is exposed;
without putting on a nut, assembling one 1⅜″ ID U-bolt onto the ¾″ conduit at a point the ¾″ conduit enters the 1″ conduit.

2. The method of claim 1, further comprising:
loosely attaching two mounting plates one to each end of the one 1⅜″ ID U-bolt with nuts, leaving other ends of the two mounting plates unattached.

3. The method of claim 2, further comprising:
assembling another 1⅜″ ID U-bolt onto the 1″ conduit and loosely attaching it to the unattached ends of the two mounting plates.

4. The method of claim 3, further comprising:
lightly tightening with a nut a U-bolt on the ¾″ conduit.

5. The method of claim 4, further comprising:
sliding the ¾″ conduit out just enough to make certain it is not grabbing the 1″ conduit and tightening it until snug.

6. The method of claim 5, further comprising:
sliding the ¾″ conduit back into the 1″ conduit until the U-bolt comes to a stop and tightening the U-bolt on the 1″ conduit.

7. The method of claim 6, further comprising:
marking the 1″ conduit 4 feet from the end and opposite of the U-bolts.

8. The method of claim 7, further comprising:
attaching an antenna array to a top of the ¾″ conduit.

9. The method of claim 8, further comprising:
inserting the ¾″ conduit/antenna array assembly into a fence post.

10. The method of claim 9, further comprising:
assembling 2″ ID U-bolts onto the fence post.

11. The method of claim 10, further comprising:
attaching a radio base station or similar equipment to the extension assembly.

12. An extension assembly comprising:
a ¾″ conduit having a line marked 2 feet from one end;
the marked end of the ¾″ conduit inserted into a 1″ conduit until about 9″ of the ¾″ conduit is exposed; and
one 1⅜″ ID U-bolt assembled onto the ¾″ conduit at a point the ¾″ conduit enters the 1″ conduit.

13. The extension assembly of claim 12, further comprising:
two mounting plates loosely attached with nuts one to each end of the one 1⅜″ ID U-bolt, leaving other ends of the two mounting plates unattached.

14. The extension assembly of claim 13, further comprising:
another 1⅜″ ID U-bolt assembled onto the 1″ conduit and loosely attached to the unattached ends of the two mounting plates.

15. The extension assembly of claim 14, further comprising:
a U-bolt lightly tightened with a nut on the ¾″ conduit.

16. The extension assembly of claim 15, further comprising:
the ¾″ conduit moved out just enough to make certain it is not grabbing the 1″ conduit and tightened until snug.

17. The extension assembly of claim 16, further comprising:
the ¾″ conduit moved back into the 1″ conduit until the U-bolt has stopped and tightened to the U-bolt on the 1″ conduit.

18. The extension assembly of claim 17, further comprising:
the 1″ conduit 4 feet from the end and opposite of the U-bolts.

19. The extension assembly of claim 18, further comprising:
an antenna array attached to a top of the ¾″ conduit.

20. A method of using an extension assembly comprising:
decoupling extension (height) from the rotation (azimuth) by adjusting the height; and
independently positioning the azimuth without a conduit suddenly falling down in a reverse telescopic way.
